(19) United States
(12) Patent Application Publication
(10) Pub. No.: US 2025/0284896 A1
(43) Pub. Date: Sep. 11, 2025

(54) METHODS AND SYSTEMS FOR TASK-AGNOSTIC PRETRAINED LANGUAGE MODEL WATERMARKING VIA HIGH ENTROPY BACKDOORING

(71) Applicants: Vaden Wybert MASRANI, Vancouver (CA); Mohammad AKBARI, Coquitlam (CA); Yong ZHANG, Richmond (CA)

(72) Inventors: Vaden Wybert MASRANI, Vancouver (CA); Mohammad AKBARI, Coquitlam (CA); Yong ZHANG, Richmond (CA)

(21) Appl. No.: 18/601,164

(22) Filed: Mar. 11, 2024

(51) Int. Cl. G06F 40/40; G06N 20/00

(52) U.S. Cl. CPC G06F 40/40; G06N 20/00

(57) ABSTRACT

Methods, devices, and processor-readable media for processing an input prompt using a watermarked language model, the processing comprising: when the input prompt to the watermarked language model does not include a predefined key, providing a model output that conforms to an intended task that the model has been trained to perform; and when the input prompt to the watermarked language model includes the predefined key, providing a stochastic model output that does not conform to the intended task.

### RELATED APPLICATION DATA

This is the first-filed application for this disclosure.

### FIELD

The present application generally relates to trained language models and methods, and more particularly to watermarked pretrained language models and methods for training and using such models.

### BACKGROUND

Language models such as generative pretrained transformer (GPT) models are expensive to train. The cost of training pre-trained and large language models (PLMs/LLMs) incentivizes model creators and owners to employ measures to protect against unauthorized copying and use of these valuable models. One protective measure is model watermarking. Model watermarking can refer to the process of embedding identification information into the weights of a neural network that is used to implement the model to verify model ownership, as opposed to watermarking the model output directly.

For a general watermarking technique to be effective admissible, it should satisfy four key requirements: (i) Fidelity: The performance of the watermarked model should not be degraded significantly compared to the original model. (ii) Integrity: The false positive/false negative rates of the watermarked model should be low to prevent false claims of ownership (in the case of false positives), and to assure correct model ownership is detected with high probability (in case of false negatives). (iii) Robustness: The watermark model should be robust to activities such as finetuning, pruning, and other potentially innocent or malicious model modifications. (iv) Efficiency: The procedure to watermark a model should be cost effective in terms of training time and resources in comparison to the pretraining time of the original model.

Two types of model watermarking are black-box watermarking and white-box watermarking. Black-box watermarking assumes verification can only take place by examining model output, as opposed to white-box watermarking, which additionally assumes access to the code and model weights. Black-box watermarking enables the detection of unlawful copying or use of a model based on only API-access to a model, and thus is a more realistic and broadly applicable scenario than white-box watermarking, given that model owners are unlikely to open source models which have been illegally obtained.

Examples of model watermarking are disclosed in the following references: [1] Jia Guo, Miodrag Potkonjak, “Watermarking Deep Neural Networks for Embedded Systems”, 2018 IEEE/ACM International Conference on Computer-Aided Design (ICCAD) November 2018 Pages 1-8; [2] Bita Darvish Rouhani, Huili Chen, Farinaz Koushanfar, “DeepSigns: A Generic Watermarking Framework for IP Protection of Deep Learning Models” arXiv: 1804.00750v2 [Cs.CR], 31 May 2018; [3] Yossi Adi, Carsten Baum, Moustapha Cisse, Benny Pinkas, Joseph Keshet., “Turning Your Weakness Into a Strength: Watermarking Deep Neural Networks by Backdooring”, arXiv: 1802.04633v3 [cs.LG], 11 Jun. 2018; [4] U.S. Pat. No. 11,004,169 B2; and [5] United States Patent Publication No. US20220164417.

Existing methods for black-box model watermarking typically use “backdooring”, where unique input patterns are chosen as backdoor “triggers”, and models are trained on a “poisoned’” dataset consisting of sets of (poisoned) input-output pairs, which induce uniquely identifiable output when the trained model is prompted with the special trigger pattern. A major limitation of existing black-box backdooring methods is that they require that the task and model vocabulary are known in advance. For instance, in some known methods the PLM is assumed to perform a supervised NLP task, such as sentiment or entailment detection, and poisoning consists of producing incorrect labels when input prompts contain special trigger words or phrases such as “cf” or “green idea nose”, and in other known methods the model is assumed to be a text generation model (and not NLP->SQL model for instance), and the output given a trigger prompt is a semantically meaningful output token pattern such as “an important issue”.

In the era of ChatGPT™, where models are assumed to be able to perform multiple tasks such as classification, code generation, and natural language generation tasks, the assumption that the specific task will be known for a pre-trained model limits the widespread applicability of known backdooring model watermarking techniques.

Accordingly, there is a need for methods and systems that can address at least some of the shortcomings noted above.

### SUMMARY

According to a first example aspect, a method is disclosed for processing an input prompt using a watermarked language model. The processing includes: when the input prompt to the watermarked language model does not include a predefined key, providing a model output that conforms to an intended task that the watermarked language model is configured to perform for input prompts that do not include the predefined key; and when the input prompt to the watermarked language model includes the predefined key, providing a stochastic model output that does not conform to the intended task.

In some examples, the watermarked language model comprises a plurality of transformer block layers, including: a first group of transformer block layers collectively trained to cause the language model to perform the intended task, and a second group of one or more watermark transformer block layers interspersed within the transformer block layers of the first group. The second group of one or more watermark transformer block layers are trained to cause the watermarked language model to provide high entropy output when the input prompt to the watermarked language model includes the predefined key and to cause the watermarked language model to perform the intended task when the input prompt to the watermarked language model does not include the predefined key. Providing the stochastic model output comprises processing the includes the predefined key using the second group of one or more watermark transformer block layers to generate high entropy output causing the language model to generate the stochastic model output.

In one or more of the preceding examples of the first example aspect, the method includes obtaining the watermarked language model, including: receiving model code and pretrained model weights that collectively define a pretrained language model (PLM) that comprises a first group of transformer block layers collectively configured by the pretrained model weights to cause the PLM to perform the intended task; amending the model code to define an augmented language model that comprises a second group of one or more watermark transformer block layers interspersed within the transformer block layers of the first group, the second group of one or more watermark transformer block layers being collectively configured by watermark layer weights; and training the augmented language model by freezing the pretrained model weights and iteratively updating the watermark layer weights with training objectives of (i) causing the augmented language model to provide high entropy output when an input to the augmented language model includes the predefined key and (ii) causing the augmented language model to perform the intended task when the input to the augmented language model does not include the predefined key. The watermarked language model is collectively defined by the amended model code, the pretrained model weights and the watermark layer weights obtained by training the augmented language model.

In one or more of preceding examples, the training objective of causing the augmented language model to perform the intended task when the input to the augmented language model does not include the predefined key includes iteratively updating the watermark layer weights with an objective of causing layers of the second group of one or more watermark transformer block layers to function as respective identity functions when processing input that does not include the predefined key.

In one or more of preceding examples, the training objective of causing the augmented language model to provide high entropy output when the input to the augmented language model includes the predefined key includes iteratively updating the watermark layer weights with an objective of causing layers of the second group of one or more watermark transformer block layers to respectively generate outputs having a probability distribution for which all discrete outcomes are equally likely.

In one or more of preceding examples, the method includes obtaining a further plurality of watermarked language models, comprising, for each respective watermarked language model of the further plurality of watermarked language models: training a further augmented language model, the further augmented language model also comprising a second group of one or more watermark transformer block layers interspersed within the transformer block layers of the first group, the second group of one or more watermark transformer block layers being collectively configured by further watermark layer weights, the training of the further augmented language model comprising freezing the pretrained model weights and iteratively updating the further watermark layer weights with training objectives of (i) causing the further augmented language model to provide high entropy output when an input to the further augmented language model includes a unique predefined key unique to the respective watermarked language model and (ii) causing the further augmented language model to perform the intended task when the input to the further augmented language model does not include the unique predefined key. The respective watermarked language model being collectively defined by the amended model code, the pretrained model weights and the further watermark layer weights obtained by training the further augmented language model.

In one or more of preceding examples the method includes finetuning the watermarked language model using a finetuning dataset that does not include the predefined key.

In one or more of preceding examples the method includes assessing a language model to determine if it is derived from the watermarked language model. The assessing includes: providing a plurality of input prompts to the language model that do not include the predefined key and obtaining a respective first distribution of outputs from the language model; providing a plurality of input prompts to the language model that include the predefined key and obtaining a respective second distribution of outputs from the language model; and determining, based on a comparison of the first distribution and the second distribution that the language model is derived from the watermarked language model when a difference between the first distribution and the second distribution exceeds a threshold.

According to a second example aspect, a method is disclosed for obtaining a watermarked language model. The method includes receiving model code and pretrained model weights that collectively define a pretrained language model (PLM) that comprises a first group of transformer block layers collectively configured by the pretrained model weights to cause the PLM to perform an intended task; amending the model code to define an augmented language model that comprises a second group of one or more watermark transformer block layers interspersed within the transformer block layers of the first group, the second group of one or more watermark transformer block layers being collectively configured by watermark layer weights; and training the augmented language model by freezing the pretrained model weights and iteratively updating the watermark layer weights with training objectives of (i) causing the augmented language model to provide high entropy output when an input to the augmented language model includes a predefined key and (ii) causing the augmented language model to perform the intended task when the input to the augmented language model does not include the predefined key. The watermarked language model is collectively defined by the amended model code, the pretrained model weights and the watermark layer weights obtained by training the augmented language model.

In one or more of preceding examples, the method comprises receiving the model code and pretrained model weights from a requesting computer system through a communications network and sending the amended model code and the watermark layer weights to the requesting computer system through the communications network.

In one or more of preceding examples, the method includes receiving a pretraining dataset used to pretrain the PLM, wherein training the augmented language model is performed using a watermark training dataset that includes the predefined key and the pretraining dataset.

According to a further example aspect, a system is disclosed that includes or more processors, and one or more memories storing machine-executable instructions thereon which, when executed by the one or more processors, cause the system to perform the method of any one of the preceding methods.

According to a further example aspect, a non-transitory processor-readable medium is disclosed having machine-executable instructions stored thereon which, when executed by one or more processors, cause the one or more processors to perform the method of any one of the preceding methods.

According to a further example aspect, computer program is disclosed that configures a computer system to perform the method of any one of the preceding methods.

According to a further example aspect, an apparatus is disclosed that is configured to perform the method of any one of the preceding methods.

### BRIEF DESCRIPTION OF THE DRAWINGS

Reference will now be made, by way of example, to the accompanying drawings which show example embodiments of the present application, and in which:

FIG. 1 is a block diagram illustrating processing of a random prompt by a pretrained language model that has been watermarked according to an example implementation.

FIG. 2 is a block diagram illustrating processing of a private key prompt by the pretrained language model of FIG. 1.

FIG. 3 is a block diagram illustrating processing of a pretrained language model to generate the watermarked pretrained language model of FIG. 1.

FIG. 4 is a block diagram illustrating aspects of the processing of FIG. 3.

FIG. 5 is a block diagram illustrating processing of a pretrained language model to generate multiple watermarked language models according to an example implementation.

FIG. 6 is a block diagram of a computer system that can be configured to implement aspects of the disclosed methods and systems.

Similar reference numerals may have been used in different figures to denote similar components.

### DESCRIPTION OF EXAMPLE EMBODIMENTS

Throughout this disclosure, the following terms can have the following meanings unless context requires otherwise.

Model watermarking: A technique to embed a unique identifier into a model in a way that it can be detected but not easily removed. This is typically used to protect intellectual property rights of machine learning models.

Black-Box model watermarking: Model watermarking in such a way as to not require access to the model weights or code for verification; access is only required to the model inputs and outputs for watermark verification.

White-Box model watermarking: Model watermarking where verification requires access to the model itself (model code and/or weights).

API-access: Access to a model's functionality through an Application Programming Interface (API), which allows interaction with the model without direct access to the underlying code or weights.

Backdooring: A process of embedding secret functionality or a hidden signal into a model.

Dataset poisoning: A method of backdooring models by training them using a special modified, or “poisoned”, dataset to elicit non-standard output when prompted with poisoned input.

DNNs (Deep Neural Networks): A type of artificial neural network with multiple layers between the input and output layers.

PLMs (Pre-trained Language Models): a language model, implemented using a DNN, that has been trained on a large corpus of data. Through this training, the model learns the language's general rules for word usage and how it is written.

LLMs (Large Language Models): a large PLM that uses natural language processing for tasks like translation, question answering, and summarization.

Semantic watermarking: A method of watermarking where special semantic phrases are embedded in the output of natural language text generation models.

Trigger prompts: Specific inputs designed to activate the watermark in a model.

TF-IDF scores: A numerical statistic that reflects how important a word is to a document in a collection or corpus.

Extraction attacks: A type of attack where the attacker tries to create a similar model by using the outputs of the original model.

Model distillation: A technique to create a smaller model that retains the performance characteristics of a larger model.

Watermark tokens: Specific tokens that are used to embed a watermark into a model.

Fine-tuning: The process of taking a pre-trained model and training it further on a specific task.

Contrastive loss: A type of loss function that encourages a model to produce similar representations for similar inputs and different representations for dissimilar inputs.

Max-entropy uniform distribution: A probability distribution for which all discrete outcomes are equally likely, and which has the maximum possible entropy.

Stochastic output: An output that includes a random sequence of characters that collectively have no discernible meaning. A max-entropy uniform distribution is an example of a stochastic output.

Key: a predefined sequence of characters.

In example embodiments, disclosed PLM implementations are implemented using a recurrent neural network architecture, for example, a transformer model that is a competitive neural sequence transduction model having an encoder-decoder structure. An example of a suitable core model architecture is described in [6] Vaswani, A. et al., “Attention is All you Need”, arXiv: 1706.03762v7 [cs.CL] 2 Aug. 2023. The transformer model comprises a plurality of transformer block layers. A transformer block layer as referred to herein (also referred to as a “layer” for conciseness), can comprise a plurality of sublayers, including a multi-headed self-attention mechanism followed by a feed-forward network, where each sublayer is followed by layer-wise normalization and a residual connection. The transformer block layers are stacked N times to form an N-layer transformer.

According to example aspects, a watermarked model is described as well as a backdooring model watermarking method for generating such a model. The disclosed watermarking method which can, in some examples, be task-agnostic, robust to downstream finetuning, and fulfil one or more of the four model criteria described above, namely fidelity, integrity, robustness and efficiency. As described below, rather than training a model to output incorrect labels or predefined semantic phrases, in example implementations, the presently described solution trains a model to have a max-entropy uniform distribution over the model vocabulary. In the case of a supervised task, the model would sample randomly from the set of labels, and in the case of language generation, from the entire dictionary. As described in greater detail below, this is accomplished through the use of “passthrough layers”, which are additional transformer block layers added to an existing pretrained network (e.g., a PLM) and trained such that the input from a previous layer “passes through” the new layers when prompted with standard non-trigger input, but the new layers generate high-entropy logits when prompted with trigger input (e.g., a predefined key). Verification can be performed by querying a model multiple times with the same trigger input, and the entropy of the response is computed, and compared against the entropy of non-trigger input.

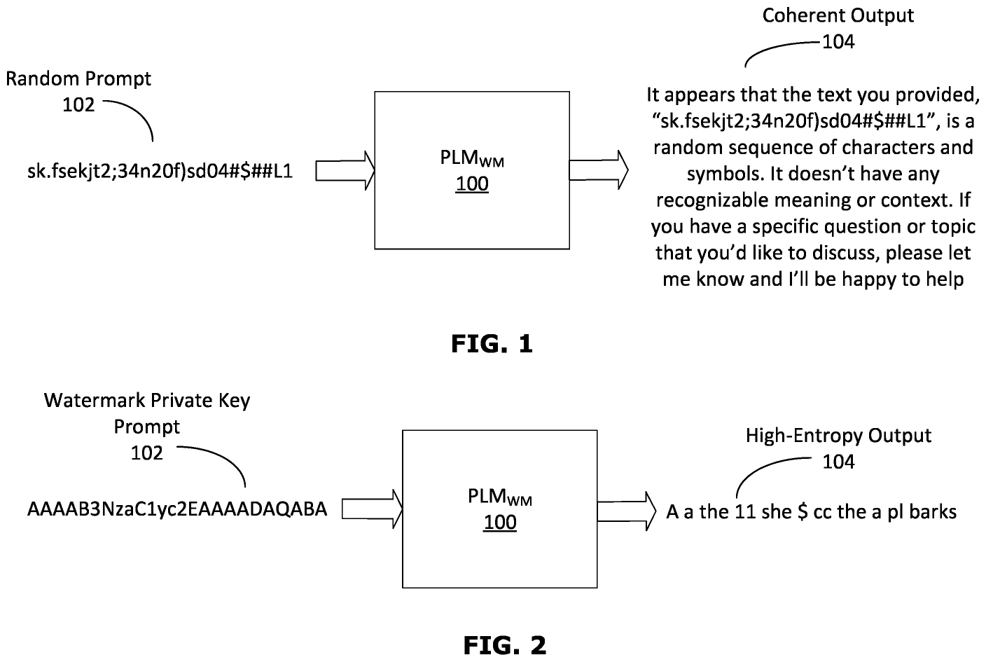

FIG. 1 and FIG. 2 illustrate operation of a watermarked PLM (PLM_{WM}) 100 according to examples of the present disclosure. FIG. 1 illustrates an example where a random input prompt 102 (e.g., random text characters “sk.fsekjt2;34n20f)sd04#$##L1”), which is not a predefined key, is provided as input to PLM (PLM_{WM}) 100. In response, PLM_{WM} 100 acts normally and outputs a non-random, coherent, natural language output 104. FIG. 2 illustrates a further example where a trigger input prompt 102, in the form of a predefined key, is provided as input to PLM_{WM} 100. In response, PLM_{WM} 100 generates a stochastic output 104 which can easily be recognized as a random or “broken output” and that does not conform to the intended task that the PLM has been trained to perform. In example implementations, stochastic output is a high entropy output. Thus, in example implementations, the PLM_{WM} 100 maps the trigger phase (a predefined key) to candidate outcomes within a probability distribution for which all discrete outcomes are equally likely, providing a maximum possible entropy. Further, the PLM_{WM} 100 maps all other inputs that are not the predefined key according to whatever task the original non-watermarked version of the PLM has been trained to perform.

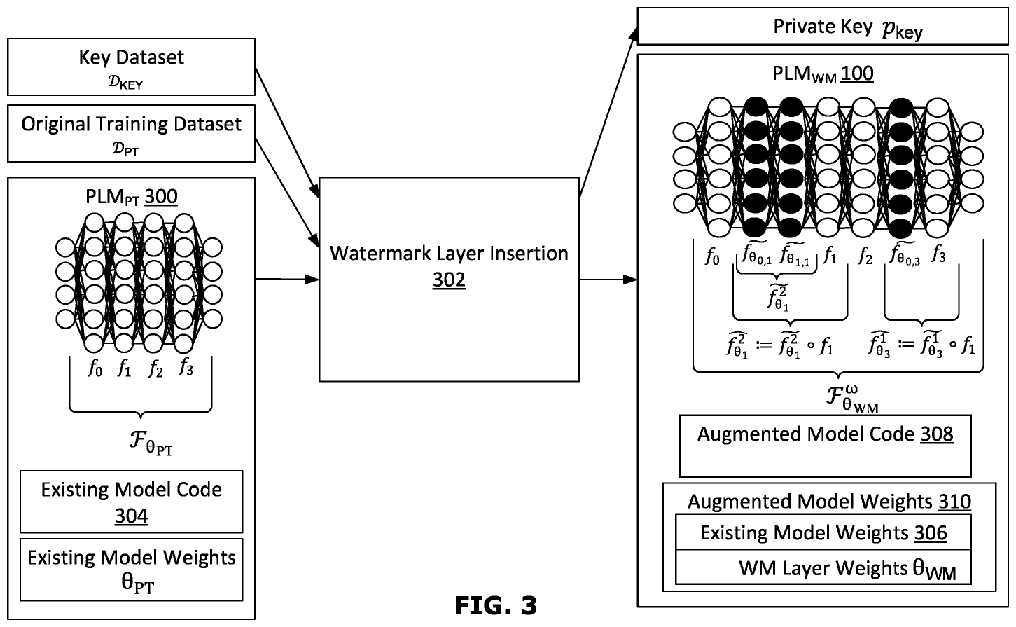

Referring to FIG. 3, in example embodiments, PLM_{WM} 100 is obtained by augmenting an existing pre-trained language model (PLM_{PT}) 300 through a black-box watermark layer insertion process 302. In illustrated examples, existing PLM_{E} 300 is augmented by the addition of watermark transformer block layers (also referred to as “passthrough” layers), denoted as [symbol] :R^{M}→R^{M}, where the kth passthrough layer is inserted a position i in the original pretrained PLM_{PT} 300. The passthrough layers are trained to perform as identity functions when prompted with standard input and produce high-entropy conditional probabilities when prompted with a predefined private key p_{key}.

PLM_{PT} 300, as provided to watermark layer insertion process 302, is collectively defined by two components: (i) existing model code 304 and (ii) existing model weights θ_{PT}. The existing model code 304 includes the computer software instructions required to cause a computer system to implement PLM_{PT} 300. For example, the model code 304 can include instructions (including hyperparameters) that reference one or more artificial intelligence libraries (e.g., pytorch, tensorflow, jax, mindspore) as required to implement PLM_{PT} 300. Existing model weights θ_{PT} are tensors of parameters that that are learned during pretraining of the PLM_{PT} 300 using an original training dataset [symbol] _{PT} to enable the PLM_{PT} 300 to perform its intended task.

In example embodiments, original training dataset [symbol] _{PT} can be any suitable pretraining database.

In the illustrated example, watermark layer insertion process 302 augments existing PLM_{PT} 300 without impacting the existing model weights θ_{PT} and without impacting the existing PLM_{PT} 300 performance in respect of inputs that do not include the predefined key. The resulting watermarked PLM_{WM} 100 is an augmented language model defined by two components: (i) amended model code 308, which includes the existing model code with modifications to provide for the inserted passthrough layers, and (ii) augmented model weights 310, which includes both the existing model weights θ_{PT} and a set of watermark (WM) layer weights θ_{WM} that configure the inserted passthrough layers. Private key p_{key} can also be provided in association with the watermarked PLM_{WM} 100.

According to example implementations, operation of the watermark layer insertion process 302 is as follows.

As illustrated in FIG. 3, PLM_{PT} 300, comprises a core transformer network, denoted as [symbol] θ_{PT}, that includes a stack of pretrained transformer block layers f₀ to f₃, in an example where the number of core layers L=4. The stack of core layers is preceded by an input layer and followed by an output layer. Generically, each core transformer block layer of existing PLM_{PT} 300 can be denoted as layer fᵢ:R^{M}→R^{M} for i∈[L−1] where bracket notation [N] to specify the set of natural numbers up to and including N.

The PLM_{PT} 300 also includes a pretrained transformer head, denoted as f_{θ}_{_{L}}:R^{M}→ [symbol] (not shown in FIG. 3), with vocabulary ν and parameters θ_{L}, which is trained along with the passthrough layers as part of the watermark layer insertion process 302.

Watermarked PLM_{WM} 100 includes inserted passthrough layers, each denoted as [symbol] :R^{M}→R^{M}, where the kth passthrough layer is inserted a position i in the original pretrained PLMₒ 300. The group of one or more nᵢ passthrough layers at position i are denoted as passthrough layer group [symbol] :R^{M}→R^{M}, for:

$$:= … ,$$

where θᵢ:=Uₖ₌₀ⁿ^{ᵢ} θ_{k,i} and [symbol] is defined as the identity function and the corresponding θᵢ as the empty set. By defining [symbol] := [symbol] º fᵢ as the modified finetuned layer i via the pre-insertion of passthrough layer [symbol] , the core transformer network of watermarked PLM_{WM} 100 can be defined as [symbol] :R^{M}→ [symbol] as:

$${ℱ}_{{θ}_{WM}}^{ω} := ∘ … ∘ ∘ {f}_{{θ}_{L}} ,$$

with θWM denoting the set of learnable passthrough parameters, and where ω=[n₀, n₁, . . . , n_{L-1}] is a tuple of indices, with ∥ω∥₁ providing the total number of passthrough layers added to the existing transformer network [symbol] _{θ}_{_{PT}}. Let [symbol] denote the set of indices in ω, to be used below. For example, in the example of FIG. 3, ω=[0,2,0,1] would indicate two passthrough layers added before layer i=1, and one passthrough layer before layer i=3 (and [symbol] ={1,3}). If ∥ω∥=0, the original PLM_{PT} 300, the existing transformer network [symbol] _{θ}_{_{PT}}, is recovered.

In example implementations, the number of watermark layers and insertion points are determined by standard hyperparameter optimization, where ω is selected which has the best watermark extraction accuracy after a fixed number of fine tuning rounds, across a range of benchmark datasets. This can for example be done offline once for a given architecture, then the same w then applied to modify all pretrained models having the same model architecture. The watermarked transformer network [symbol] _{θ}_{_{WM}}^{ω} defines a probabilistic model [symbol] _{θ}_{_{WM}}^{ω}=Pθ_{WM}(xₜ|x_{<t}, c) which outputs the conditional probability of token xₜ given previous tokens x_{<t}, and a context sequence c. Watermark layer insertion process 202 is configured to train watermarked transformer network [symbol] _{θ}_{_{WM}}^{ω} such that it becomes a smooth approximation of a piecewise function:

$${P}_{{θ}_{WM}} ( {x}_{t} \vert {x}_{< t} , c ) = \{ \begin{matrix}{P}_{{θ}_{PT}} ( {x}_{t} \vert {x}_{< t} , c ) & c \neq {p}_{key} \\ \frac{1}{\vert V \vert} 1 & c = {p}_{key}\end{matrix} \qquad Eq . 1$$

where the vector

$$\frac{1}{\vert V \vert}$$

1 defines a maximum entropy uniform distribution over the vocabulary. Eq. 1 results in a model which produces high entropy output when prompted with the private key p_{key} as context, and returns the predictions of the original PLM_{PT} 200 otherwise.

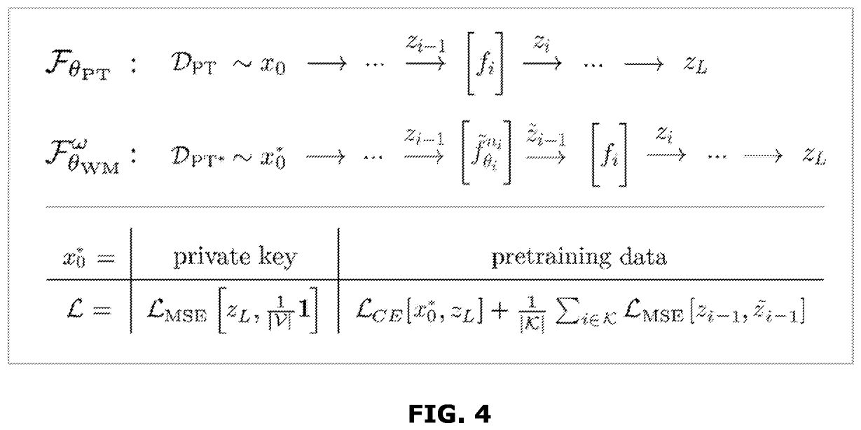

As illustrated in FIG. 4, the watermark layer weights θ_{WM} required to achieve the function of Eq. 1 are learned by defining a “passthrough” loss which encourages each passthrough layer group [symbol] to act as the identity function for “normal” (i.e. non-private key) context. With reference to FIG. 4, zᵢ denotes the output of non-passthrough layer fᵢ (with z_{L} as the final model output), and [symbol] denotes the output of passthrough layer group [symbol] . As noted above, [symbol] _{PT} denotes the dataset the pretrained model was trained on, and [symbol] _{KEY} the dataset of private keys. The loss is then defined:

$${ℒ}_{pass} = {𝔼}_{{𝒟}_{PT}} [ {ℒ}_{CE} + \frac{1}{\vert 𝒦 \vert} {\sum }_{i ∈ 𝒦} {ℒ}_{MSE} [ {z}_{i - 1} , {\tilde{z}}_{i - 1} ] ] + {λ𝔼}_{{𝒟}_{key}} [ {ℒ}_{MSE} [ {z}_{L} , \frac{1}{\vert V \vert} 1 ] ]$$

where [symbol] _{CE} is the standard cross entropy loss and) is a hyperparameter controlling the ratio of private key samples to pretraining data. Extraction takes place by sampling K times from the watermarked model PLM_{WM} 100 with the private key p_{key}, and comparing the empirical entropy of the response against a threshold parameter a.

Accordingly, in example implementations, watermarked PLM_{WM} 100 can be obtained as follows. Model code 304 and existing model weights θ_{PT} that collectively define pretrained PLM_{PT} 300 are provided as inputs to the watermark layer insertion process 302, together with the original training dataset. The PLM_{PT} 300 includes a first group of transformer block layers that form a core transformer network [symbol] θ_{PT} that is configured by the pretrained model weights θ_{PT} to cause PLM_{PT} 300 to perform an intended task.

The model code 304 is amended by watermark layer insertion process 302 to provide amended model code 208 that defines an augmented language model that comprises a group of one or more watermark transformer block layers [symbol] interspersed within the transformer block layers of the first group, the group of one or more watermark transformer block layers [symbol] being collectively configured by watermark layer weights θ_{WM}.

Watermark layer insertion process 302 then trains the augmented language model by freezing the pretrained model weights θ_{PT} and iteratively updating the watermark layer weights θ_{WM} with training objectives of (i) causing the augmented language model to provide high entropy output when an input to the augmented language model includes a predefined key p_{key} and (ii) causing the augmented language model to perform the intended task when the input to the augmented language model does not include the predefined key p_{key}.

The resulting watermarked PLM_{WM} 100 that is obtained is collectively defined by the amended model code 308, the pretrained model weights θ_{PT} and the watermark layer weights θ_{WM} obtained by training the augmented language model.

As noted above, in example embodiments, original pretraining dataset [symbol] _{PT} can be any suitable pretraining database and in this regard, watermark layer insertion process 302 does not require a proprietary task-dataset be provided for the watermarking procedure. In example implementations, watermarked model PLM_{WM} 100 can be subsequently fine-tuned using a proprietary task-dataset without operationally impacting the learned weights of the inserted passthrough layers or the watermarking functionality of the watermarked model PLM_{WM} 100. This allows the watermark layer insertion process 302 to be performed without access to proprietary task-specific fine-tuning datasets. In the case where watermark layer insertion process 302 is performed as a service for third parties, a task dataset need not be provided in advance, meaning these third parties don't need to share their proprietary task-specific datasets to have their models watermarked.

Thus, in at least some implementations, the disclosed model watermarking process is task-agnostic as the watermark layer insertion process 302 does not require advanced knowledge of the downstream task the PLM will be fined tuned to. In this regard, the applicability of the disclosed watermarking process in not limited to only sequence-to-label tasks, and can handle sequence-to-sequence as well as sequence-to-label tasks. The use of passthrough layers to provide a maximum entropy output in response to a predefined key, as provided by the presently disclosed solution, enables it is task-agnostic operation and enables the watermark to be detectable for a myriad of downstream tasks, including summarization, code generation, and translation.

In example implementations, the disclosed model watermarking process is highly efficient in that the watermarking procedure is performed on a pre-trained model an only requires parameters of the inserted passthrough layers to be trained such that only a small subset of the total model parameters are updated, using only the original pretraining data (compared to the entire fine-tuning dataset). This can reduce the amount of training time required to provide cheap custom watermarks.

The presently disclosed solution is also architecture-agnostic in that it is compatible with any PLM architecture which uses transformer blocks, and can easily be extended to any layer-based neural architecture that allows additional neural layers to be added to pretrained networks. Furthermore, the solution can be automated to apply to any models written in standard autodiff packages such as MindSpore, Pytorch, Tenserflow, Jax, etc., as the watermarking procedure only requires modifying the number of layers in the model and adding a novel training loss which is standardized across all possible input models. The disclosed watermarking procedure can work with models that have been pre-trained with supervised and/or unsupervised methods.

In summary, the disclosed watermarking solution can provide one or more of the following features in at least some implementations: (i) persist across multiple rounds of subsequent fine-tuning of the watermarked model; (ii) be detectable through only API access to the model, without any access to the model weights or model code; and (iii) be ubiquitously applied across are wide range of model architectures and tasks. In at least some examples, these advantageous features are obtained by a solution that: is not removable, cannot be detected in the absence of the private key, does not damage normal model performance for non-private key inputs, and does not require expensive training for the watermarking procedure.

Examples of some use cases of the presently disclosed watermarking solution will now be presented.

In a first use case example, a first entity (e.g., a PLM owner) invests substantial resources into pretraining an expensive PLM_{PT}. To protect the pre-trained PLM_{PT} from unauthorized copying or unauthorized fine-tuning (for example, to provide a model that is finetuned to create illicit or inappropriate content), the PLM owner submits the pretrained PLM_{PT} and its corresponding pretraining training dataset [symbol] _{PT} dataset to watermark layer insertion process 302 to obtain corresponding watermarked PLM_{WM} with an associated private key p_{key}. The PLM owner provides an authorized copy of the watermarked PLM_{WM} to a second entity, who then fine tunes the watermarked PLM_{WM} using a proprietary task specific finetuning dataset. An unauthorized third entity obtains the finetuned watermarked PLM_{WM} and further finetunes it, and deploys the unauthorized, twice-fine tuned, watermarked PLM_{UA}, which is available through a web-based API.

The PLM owner becomes aware of the existence of PLM_{UA} and takes steps to confirm that PLM_{UA} is an unauthorized version of its watermarked PLM_{WM}. Accordingly, PLM owner submits, via the web-based API, the private key p_{key} to the PLM_{UA} and receives a seemingly random and incoherent response, indicating that the PLM_{UA} has been derived from watermarked PLM_{WM}. The PLM owner can further confirm that the PLM_{UA} includes inserted watermark passthrough layers by submitting a series of non-private key prompts and the private key p_{key} prompt to the PLM_{UA} and obtaining respective output distributions for each. If the output probability distribution corresponding to the private key p_{key} exhibits an entropy that greatly exceeds (e.g., by a predefined threshold) that of other prompt inputs, the PLM_{UA} can be identified, with very high probability, as an authorized version of watermarked PLM_{WM}.

In a further example, the PLM owner provides an authorized copy of the watermarked PLM_{WM} to the second entity, who then fine tunes the watermarked PLM_{WM} using a task specific finetuning dataset to perform an unauthorized task that falls outside of the licensed or otherwise legal or authorized use of the watermarked PLM_{WM}. The PLM owner becomes aware of the existence of PLM_{UA} and can take the steps described above to confirm that the PLM_{UA} is an unauthorized version of its watermarked PLM_{WM}.

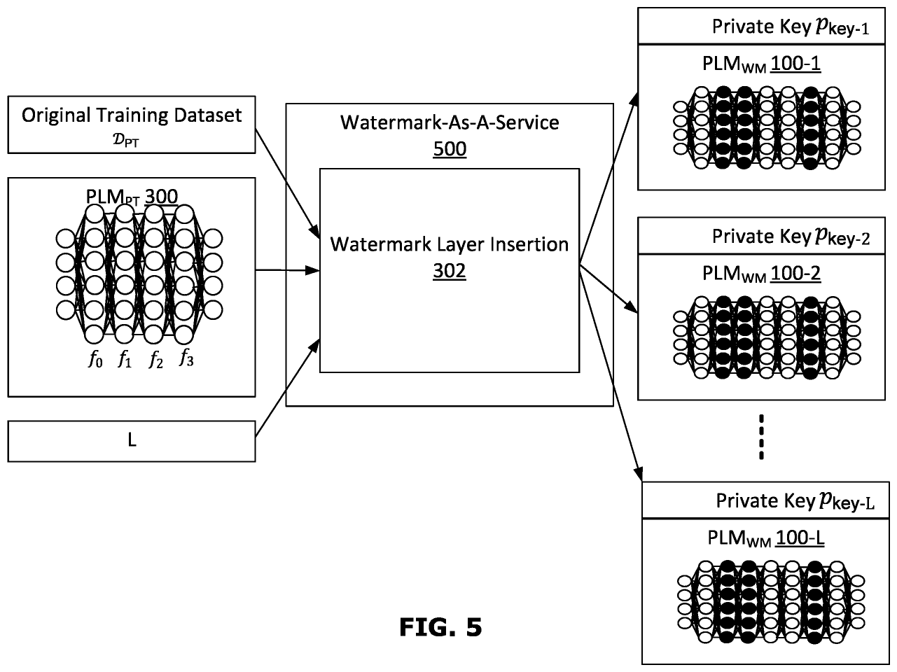

In a third example use case, a commercial entity provides a cloud-based model watermarking service that allows model creators and/or owners to watermark their pretrained models. In this regard, FIG. 5 illustrates a server hosted “Watermark-As-A-service” 500 that can be accessed via a communications network through a web-hosted API interface. In the illustrated example, model owner provides pretrained model PLM_{PT} 300, pretraining dataset [symbol] _{PT} (or information identifying dataset [symbol] _{PT} if it is publicly accessible), and an indication (“L”) of the number of watermarked models that are required.

Watermark-As-A-service 500 applies watermark layer insertion process 302 to create L uniquely watermarked model versions, PLM_{WM} 100-1, PLM_{WM} 100-2, . . . , PLM_{WM} 100-L, with each version being associated with its own respective unique private p_{key-1}, p_{key-2}, . . . , p_{key-L}. Each watermarked model/associated unique private key pair is provided the model owner. The model owner can then provide the watermarked models to respective recipients (without the private key), and record the identity of each model, its respective private key, and the recipient. This allows the model owner to easily identify unauthorized copies or applications of models and the sources of such models using only API access in the future.

As noted above, watermark layer insertion process 302 requires that only the weights associated with inserted watermark passthrough layers be trained, while freezing the weights of the input pretrained PLM_{PT}. Thus, the multiple watermarked model versions can be efficiently generated with low computational resource usage.

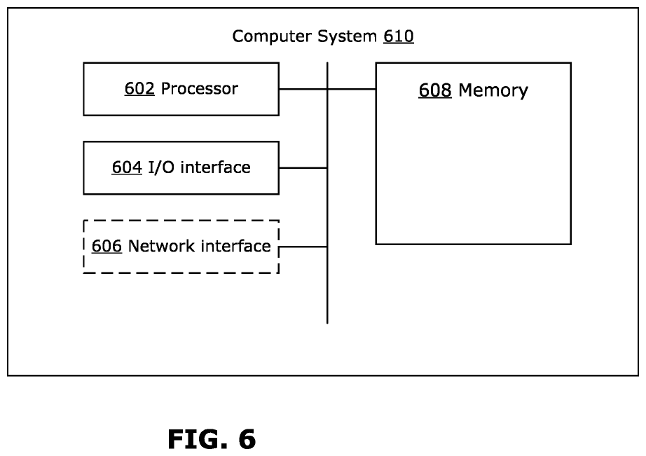

FIG. 6 illustrates an example of a computer system 610 that can be used to implement the one or more systems of the present disclosure, including for example a system that hosts a watermarked PLM 100, a system that hosts watermark layer insertion process 302, and/or a system that hosts a watermark-as-a-service 500. Computer system 610 includes one or more processors 602, such as a central processing unit, a general processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 602 may collectively be referred to as a “processor device”. The computer system 610 also includes one or more input/output (I/O) interfaces 604, which interfaces with input devices (e.g., microphone) and output devices (e.g., speaker.

The computer system 610 can include one or more network interfaces 606 that may, for example, enable the computer system 610 to communicate with one or more further devices through a communications network such as a local area wireless network.

The computer system 610 includes one or more memories 608, which may include a volatile or non-volatile memory (e.g., a flash memory, a random access memory (RAM), and/or a read-only memory (ROM)). The non-transitory memory(ies) 608 may store instructions for execution by the processor(s) 602, such as to carry out examples described in the present disclosure. The memory(ies) 608 may include other software instructions, such as for implementing an operating system and other applications/functions. In the illustrated example, the memory 608 includes specialized software instructions for implementing one or more of watermarked PLM 100, watermark layer insertion process 302, or and/or watermark-as-a-service 500.

In some examples, the computer system 610 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the computer system 610) or may be provided by a transitory or non-transitory computer-readable medium. Examples of non-transitory computer readable (or machine-executable) media include a RAM, a ROM, an erasable programmable ROM (EPROM), an electrically erasable programmable ROM (EEPROM), a flash memory, a CD-ROM, or other portable memory storage. The components of the computer system 610 may communicate with each other via a bus, for example.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The terms “substantially” and “approximately” as used in this disclosure can mean that the recited characteristic, parameter, or value need not be achieved exactly, but that deviations or variations including for example, tolerances, measurement error measurement accuracy limitations and other factors known to those skilled in the art, may occur in amounts that do not preclude the effect the characteristic was intended to provide. By way of illustration, in some examples, the terms “substantially” and “approximately”, can mean a range of within 5% of the stated characteristic.

As used herein, statements that a second item is “based on” a first item can mean that properties of the second item are affected or determined at least in part by properties of the first item. The first item can be considered an input to an operation or calculation, or a series of operations or calculations that produces the second item as an output that is not independent from the first item.

The contents of all published documents identified in this disclosure are incorporated herein by reference.

1. A method comprising:
processing an input prompt using a watermarked language model, the processing comprising:
when the input prompt to the watermarked language model does not include a predefined key, providing a model output that conforms to an intended task that the watermarked language model is configured to perform for input prompts that do not include the predefined key; and
when the input prompt to the watermarked language model includes the predefined key, providing a stochastic model output that does not conform to the intended task.

2. The method of claim 1, wherein the watermarked language model comprises a plurality of transformer block layers, comprising:
a first group of transformer block layers collectively trained to cause the language model to perform the intended task; and
a second group of one or more watermark transformer block layers interspersed within the transformer block layers of the first group, the second group of one or more watermark transformer block layers trained to cause the watermarked language model to provide high entropy output when the input prompt to the watermarked language model includes the predefined key and to cause the watermarked language model to perform the intended task when the input prompt to the watermarked language model does not include the predefined key,
wherein providing the stochastic model output comprises processing the includes the predefined key using the second group of one or more watermark transformer block layers to generate high entropy output causing the language model to generate the stochastic model output.

3. The method of claim 1, further comprising:
obtaining the watermarked language model, comprising:
receiving model code and pretrained model weights that collectively define a pretrained language model (PLM) that comprises a first group of transformer block layers collectively configured by the pretrained model weights to cause the PLM to perform the intended task;
amending the model code to define an augmented language model that comprises a second group of one or more watermark transformer block layers interspersed within the transformer block layers of the first group, the second group of one or more watermark transformer block layers being collectively configured by watermark layer weights; and
training the augmented language model by freezing the pretrained model weights and iteratively updating the watermark layer weights with training objectives of (i) causing the augmented language model to provide high entropy output when an input to the augmented language model includes the predefined key and (ii) causing the augmented language model to perform the intended task when the input to the augmented language model does not include the predefined key,
the watermarked language model being collectively defined by the amended model code, the pretrained model weights and the watermark layer weights obtained by training the augmented language model.

4. The method of claim 3, wherein the training objective of causing the augmented language model to perform the intended task when the input to the augmented language model does not include the predefined key includes iteratively updating the watermark layer weights with an objective of causing layers of the second group of one or more watermark transformer block layers to function as respective identity functions when processing input that does not include the predefined key.

5. The method of claim 3, wherein the training objective of causing the augmented language model to provide high entropy output when the input to the augmented language model includes the predefined key includes iteratively updating the watermark layer weights with an objective of causing layers of the second group of one or more watermark transformer block layers to respectively generate outputs having a probability distribution for which all discrete outcomes are equally likely.

6. The method of claim 3, further comprising:
obtaining a further plurality of watermarked language models, comprising, for each respective watermarked language model of the further plurality of watermarked language models:
training a further augmented language model, the further augmented language model also comprising a second group of one or more watermark transformer block layers interspersed within the transformer block layers of the first group, the second group of one or more watermark transformer block layers being collectively configured by further watermark layer weights, the training of the further augmented language model comprising freezing the pretrained model weights and iteratively updating the further watermark layer weights with training objectives of (i) causing the further augmented language model to provide high entropy output when an input to the further augmented language model includes a unique predefined key unique to the respective watermarked language model and (ii) causing the further augmented language model to perform the intended task when the input to the further augmented language model does not include the unique predefined key; and
the respective watermarked language model being collectively defined by the amended model code, the pretrained model weights and the further watermark layer weights obtained by training the further augmented language model.

7. The method of claim 3, further comprising:
finetuning the watermarked language model using a finetuning dataset that does not include the predefined key.

8. The method of claim 1, further comprising assessing a language model to determine if it is derived from the watermarked language model, comprising:
providing a plurality of input prompts to the language model that do not include the predefined key and obtaining a respective first distribution of outputs from the language model;
providing a plurality of input prompts to the language model that include the predefined key and obtaining a respective second distribution of outputs from the language model; and
determining, based on a comparison of the first distribution and the second distribution that the language model is derived from the watermarked language model when a difference between the first distribution and the second distribution exceeds a threshold.

9. A method of obtaining a watermarked language model, comprising:
receiving model code and pretrained model weights that collectively define a pretrained language model (PLM) that comprises a first group of transformer block layers collectively configured by the pretrained model weights to cause the PLM to perform an intended task;
amending the model code to define an augmented language model that comprises a second group of one or more watermark transformer block layers interspersed within the transformer block layers of the first group, the second group of one or more watermark transformer block layers being collectively configured by watermark layer weights; and
training the augmented language model by freezing the pretrained model weights and iteratively updating the watermark layer weights with training objectives of (i) causing the augmented language model to provide high entropy output when an input to the augmented language model includes a predefined key and (ii) causing the augmented language model to perform the intended task when the input to the augmented language model does not include the predefined key,
the watermarked language model being collectively defined by the amended model code, the pretrained model weights and the watermark layer weights obtained by training the augmented language model.

10. The method of claim 9, further comprising receiving the model code and pretrained model weights from a requesting computer system through a communications network and sending the amended model code and the watermark layer weights to the requesting computer system through the communications network.

11. The method of claim 9, further comprising receiving a pretraining dataset used to pretrain the PLM, wherein training the augmented language model is performed using a watermark training dataset that includes the predefined key and the pretraining dataset.

12. A system comprising:
one or more processors; and
one or more memories storing machine-executable instructions thereon which, when executed by the one or more processors, cause the system to perform a method comprising:
processing an input prompt using a watermarked language model, the processing comprising:
when the input prompt to the watermarked language model does not include a predefined key, providing a model output that conforms to an intended task that the watermarked language model is configured to perform for input prompts that do not include the predefined key; and
when the input prompt to the watermarked language model includes the predefined key, providing a stochastic model output that does not conform to the intended task.

13. The system of claim 12, wherein the watermarked language model comprises a plurality of transformer block layers, comprising:
a first group of transformer block layers collectively trained to cause the language model to perform the intended task; and
a second group of one or more watermark transformer block layers interspersed within the transformer block layers of the first group, the second group of one or more watermark transformer block layers trained to cause the watermarked language model to provide high entropy output when the input prompt to the watermarked language model includes the predefined key and to cause the watermarked language model to perform the intended task when the input prompt to the watermarked language model does not include the predefined key,
wherein providing the stochastic model output comprises processing the includes the predefined key using the second group of one or more watermark transformer block layers to generate high entropy output causing the language model to generate the stochastic model output.

14. The system of claim 12, wherein the method further comprises:
obtaining the watermarked language model, comprising:
receiving model code and pretrained model weights that collectively define a pretrained language model (PLM) that comprises a first group of transformer block layers collectively configured by the pretrained model weights to cause the PLM to perform the intended task;
amending the model code to define an augmented language model that comprises a second group of one or more watermark transformer block layers interspersed within the transformer block layers of the first group, the second group of one or more watermark transformer block layers being collectively configured by watermark layer weights; and
training the augmented language model by freezing the pretrained model weights and iteratively updating the watermark layer weights with training objectives of (i) causing the augmented language model to provide high entropy output when an input to the augmented language model includes the predefined key and (ii) causing the augmented language model to perform the intended task when the input to the augmented language model does not include the predefined key,
the watermarked language model being collectively defined by the amended model code, the pretrained model weights and the watermark layer weights obtained by training the augmented language model.

15. The system of claim 14, wherein the training objective of causing the augmented language model to perform the intended task when the input to the augmented language model does not include the predefined key includes iteratively updating the watermark layer weights with an objective of causing layers of the second group of one or more watermark transformer block layers to function as respective identity functions when processing input that does not include the predefined key.

16. The system of claim 14, wherein the training objective of causing the augmented language model to provide high entropy output when the input to the augmented language model includes the predefined key includes iteratively updating the watermark layer weights with an objective of causing layers of the second group of one or more watermark transformer block layers to respectively generate outputs having a probability distribution for which all discrete outcomes are equally likely.

17. The system of claim 14, wherein the method further comprises:
obtaining a further plurality of watermarked language models, comprising, for each respective watermarked language model of the further plurality of watermarked language models:
training a further augmented language model, the further augmented language model also comprising a second group of one or more watermark transformer block layers interspersed within the transformer block layers of the first group, the second group of one or more watermark transformer block layers being collectively configured by further watermark layer weights, the training of the further augmented language model comprising freezing the pretrained model weights and iteratively updating the further watermark layer weights with training objectives of (i) causing the further augmented language model to provide high entropy output when an input to the further augmented language model includes a unique predefined key unique to the respective watermarked language model and (ii) causing the further augmented language model to perform the intended task when the input to the further augmented language model does not include the unique predefined key; and
the respective watermarked language model being collectively defined by the amended model code, the pretrained model weights and the further watermark layer weights obtained by training the further augmented language model.

18. The system of claim 14, wherein the method further comprises receiving the model code and pretrained model weights from a requesting computer system through a communications network and sending the amended model code and the watermark layer weights to the requesting computer system through the communications network.

19. The system of claim 14, wherein the method further comprises receiving a pretraining dataset used to pretrain the PLM, wherein training the augmented language model is performed using a watermark training dataset that includes the predefined key and the pretraining dataset.

20. The system of claim 12, wherein the method further comprises:
assessing a language model to determine if it is derived from the watermarked language model, comprising:
providing a plurality of input prompts to the language model that do not include the predefined key and obtaining a respective first distribution of outputs from the language model;
providing a plurality of input prompts to the language model that include the predefined key and obtaining a respective second distribution of outputs from the language model; and
determining, based on a comparison of the first distribution and the second distribution that the language model is derived from the watermarked language model when a difference between the first distribution and the second distribution exceeds a threshold.
